(19) United States
(12) Patent Application Publication
(10) Pub. No.: US 2021/0097651 A1
(43) Pub. Date: Apr. 1, 2021

(54) IMAGE PROCESSING METHOD AND APPARATUS, ELECTRONIC DEVICE, AND STORAGE MEDIUM

(71) Applicant: SHENZHEN SENSETIME TECHNOLOGY CO., LTD., Shenzhen (CN)

(72) Inventors: Sijie REN, Shenzhen (CN); Kun CHEN, Shenzhen (CN); Xiaohao CHEN, Shenzhen (CN)

(21) Appl. No.: 17/119,918

(22) Filed: Dec. 11, 2020

Related U.S. Application Data
(63) Continuation of application No. PCT/CN2018/123872, filed on Dec. 26, 2018.

(30) Foreign Application Priority Data
Oct. 30, 2018 (CN) 201811278997.1

(51) Int. Cl. G06T 5/00; G06T 5/20; G06T 5/50; G06T 3/40

(52) U.S. Cl. CPC G06T 5/002; G06T 5/009; G06T 2207/20024; G06T 5/50; G06T 3/40; G06T 5/20

(57) ABSTRACT

An image processing method and apparatus, and a computer-readable storage medium are provided. The method includes: determining a target filter kernel; performing, according to the target filter kernel and depth of field information corresponding to an input image, filtering and distinguishing processing on the input image to obtain a non-background area and a blurred background area of the input image; and blending the non-background area and the blurred background area to obtain a background-blurred image.

### CROSS REFERENCE TO RELATED APPLICATIONS

This application is a continuation of International Patent Application No. PCT/CN2018/123872, filed on Dec. 26, 2018, which claims priority to Chinese Patent Application No. 201811278997.1, filed on Oct. 30, 2018. The disclosures of International Patent Application No. PCT/CN2018/123872 and Chinese Patent Application No. 201811278997.1 are incorporated herein by reference in their entireties.

### BACKGROUND

With the continuous development of electronic technology, a terminal has long been a device integrating functions such as leisure, communication, and entertainment, etc., and is not limited to the single function of communication only. For example, common terminals are all provided with cameras for satisfying still-photography or video-photography needs of users.

At present, because a terminal, such as a mobile phone and a tablet computer, cannot be configured with a related optical device due to the limitation of volume, the terminal generally uses a software algorithm to post-process an image to obtain a background-blurred effect. However, at present, a common software algorithm process with a spot effect is complicated, takes a long time, and cannot support real-time preview.

### SUMMARY

The present disclosure relates to the technical field of image processing Embodiments of the present disclosure are expected to provide an image processing method and apparatus, an electronic device, and a storage medium. By performing filtering and distinguishing processing on an input image, and blending an obtained blurred background area and a non-background area of the input image, a background-blurred image with a spot effect can be obtained in a short time, thereby supporting the real-time preview display of the background-blurred image, and enabling the effect obtained by photographing to be consistent with the effect seen.

The technical solution in the embodiments of the present disclosure is achieved as below.

The embodiments of the present disclosure provide an image processing method, including: determining a target filter kernel; performing, according to the target filter kernel and depth of field information corresponding to an input image, filtering and distinguishing processing on the input image to obtain a non-background area and a blurred background area of the input image; and blending the non-background area and the blurred background area to obtain a background-blurred image.

The embodiments of the present disclosure provide an image processing apparatus, including: a determining portion, configured to determine a target filter kernel; an acquiring portion, configured to perform, according to the target filter kernel and depth of field information corresponding to an input image, filtering and distinguishing processing on the input image to obtain a non-background area and a blurred background area of the input image; and an imaging portion, configured to blend the non-background area and the blurred background area to obtain a background-blurred image.

The embodiments of the present disclosure provide an electronic device, including: a processor, a memory, and a communication bus, where the communication bus is configured to implement connection communication between the processor and the memory, and the processor is configured to execute an image processing program stored in the memory to implement the image processing method.

The present disclosure provides a computer-readable storage medium, where the computer-readable storage medium stores one or more programs, and the one or more programs may be executed by one or more processors to implement the image processing method.

### BRIEF DESCRIPTION OF THE DRAWINGS

FIG. 1 is a schematic flowchart of an image processing method provided by the embodiments of the present disclosure;

FIG. 2 is a schematic flowchart of determining a target filter kernel provided by the embodiments of the present disclosure;

FIG. 3A is a first schematic diagram of an exemplary first template image provided by the embodiments of the present disclosure;

FIG. 3B is a second schematic diagram of an exemplary first template image provided by the embodiments of the present disclosure;

FIG. 4 is a schematic transformation curve of an exemplary predetermined brightness transformation mode provided by the embodiments of the present disclosure;

FIG. 5A is a first schematic real-time preview display diagram of an exemplary background-blurred image provided by the embodiments of the present disclosure;

FIG. 5B is a second schematic real-time preview display diagram of an exemplary background-blurred image provided by the embodiments of the present disclosure;

FIG. 5C is a second schematic real-time preview display diagram of an exemplary background-blurred image provided by the embodiments of the present disclosure;

FIG. 6 is a schematic structural diagram of an image processing apparatus provided by the embodiments of the present disclosure; and

FIG. 7 is a schematic structural diagram of an electronic device according to the embodiments of the present disclosure.

### DETAILED DESCRIPTION

The technical solution in the embodiments of the present disclosure is clearly and completely described below with reference to the drawings in the embodiments of the present disclosure.

### Embodiment I

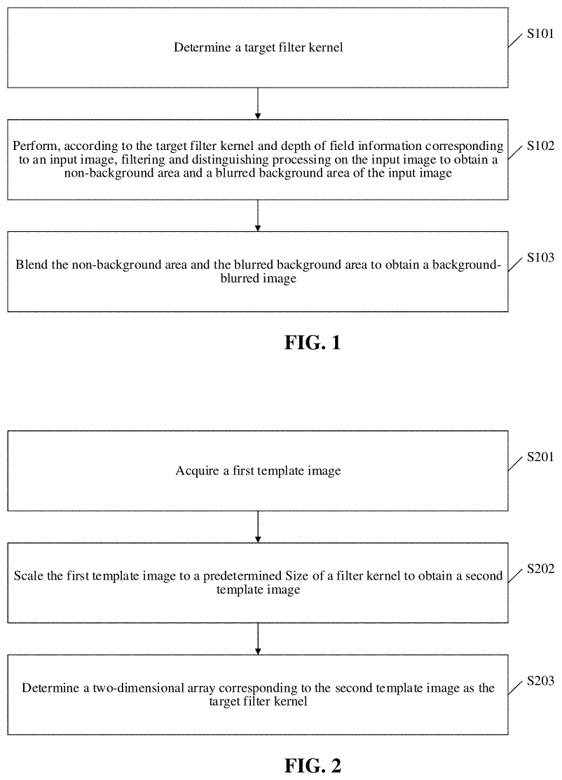

The present disclosure provides an image processing method. FIG. 1 is a schematic flowchart of an image processing method provided by the present disclosure. The image processing method can be applied to or implemented by a terminal device such as a mobile phone or a tablet computer. As shown in FIG. 1, the following steps are mainly included.

At S101, a target filter kernel is determined.

In the embodiments of the present disclosure, an image processing apparatus may first determine the target filter kernel for performing subsequent processing steps on an input image.

FIG. 2 is a schematic flowchart of determining a target filter kernel provided by the embodiments of the present disclosure. As shown in FIG. 2, specific steps of determining the target filter kernel by an image processing apparatus are as follows.

At S201, a first template image is acquired. In the embodiments of the present disclosure, the image processing apparatus may acquire the first template image. The first template image is an original image template corresponding to the target filter kernel.

It should be noted that, in the embodiments of the present disclosure, before determining the target filter kernel, the image processing apparatus may receive a selection instruction sent by a user. The selection instruction includes a spot type, such as the shape and orientation of a spot. The image is a corresponding first template image that can be obtained from other storage devices according to the spot type in the selection instruction or in any manner. The specific selection instruction and the method for acquiring the first template image are not limited in the embodiments of the present disclosure.

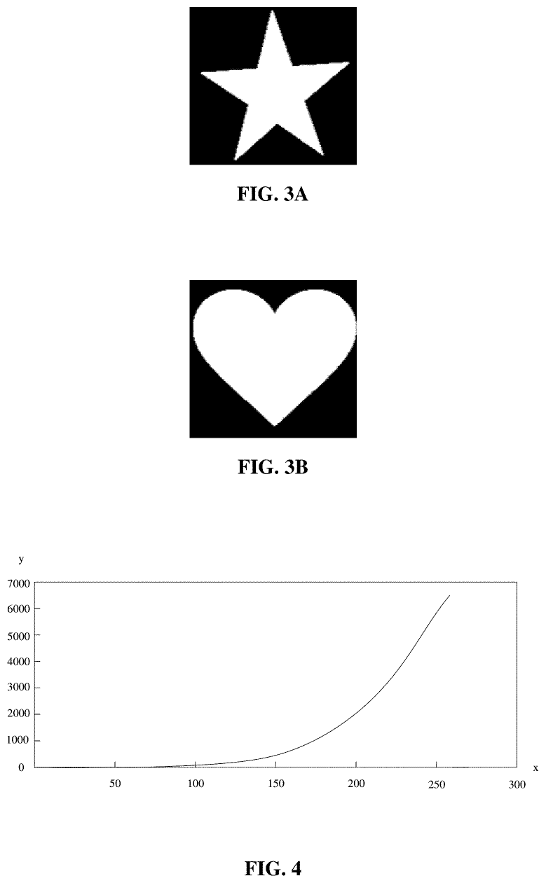

FIG. 3A is a first schematic diagram of an exemplary first template image provided by embodiments of the present disclosure. In the embodiments of the present disclosure, the target filter kernel may be a pentagonal filter kernel. In order to determine the pentagonal filter kernel, the image processing apparatus needs to first obtain the first template image as shown in FIG. 3A.

FIG. 3B is a second schematic diagram of an exemplary first template image provided by embodiments of the present disclosure. In the embodiments of the present disclosure, the target filter kernel may be a heart-shaped filter kernel. In order to determine the heart-shaped filter kernel, the image processing apparatus needs to first obtain the first template image as shown in FIG. 3B.

At S202, the first template image is scaled to a predetermined size of a filter kernel to obtain a second template image.

In the embodiments of the present disclosure, after acquiring the first template image, the image processing apparatus may scale the first template image to the predetermined filter kernel size to obtain the second template image.

It should be noted that, in the embodiments of the present disclosure, the image processing apparatus stores the predetermined filter kernel size for defining a specific size of a generated filter kernel. The specific predetermined filter kernel size is not limited in the embodiments of the present disclosure.

Exemplarily, in the embodiments of the present disclosure, the predetermined size of the filter kernel is 9×9. Therefore, after acquiring the first template image, the image processing apparatus scales the first template image to 9×9.

It can be understood that, in the embodiments of the present disclosure, the first template image may be too large or too small, and therefore, the image processing apparatus needs to scale the first template image to an actually required size, i.e., scaling to the predetermined filter kernel size, so that a suitable filter kernel can be further generated.

At S203, a two-dimensional array corresponding to the second template image is determined as the target filter kernel.

In the embodiments of the present disclosure, after acquiring the second template image, the image processing apparatus determines the two-dimensional array corresponding to the second template image as the target filter kernel.

It should be noted that, in the embodiments of the present disclosure, each numerical value in the two-dimensional array corresponding to the second template image indicates a pixel value of a corresponding area in the second template image. The specific two-dimensional array corresponding to the second template image is not limited in the embodiments of the present disclosure.

Exemplarily, in the embodiments of the present disclosure, the target filter kernel is a pentagonal filter kernel, and the predetermined size of the filter kernel is 9×9. Therefore, the first template image acquired by the image processing apparatus is as shown in FIG. 3A. After the first template image is scaled to the size of 9×9 to obtain the second template image, the two-dimensional array corresponding to the second template image is determined as the pentagonal filter kernel. The specific pentagonal filter kernel is as shown in formula (1):

$$\frac{1}{2979} [ \begin{matrix}0 & 0 & 0 & 3 & 33 & 0 & 0 & 0 & 0 \\ 0 & 0 & 0 & 12 & 99 & 5 & 0 & 0 & 0 \\ 0 & 0 & 0 & 30 & 132 & 30 & 0 & 3 & 3 \\ 9 & 54 & 60 & 91 & 132 & 107 & 99 & 95 & 16 \\ 2 & 58 & 129 & 132 & 132 & 132 & 113 & 25 & 0 \\ 0 & 0 & 25 & 123 & 132 & 132 & 37 & 0 & 0 \\ 0 & 0 & 22 & 132 & 105 & 132 & 72 & 0 & 0 \\ 0 & 0 & 55 & 90 & 2 & 35 & 93 & 5 & 0 \\ 0 & 0 & 28 & 7 & 0 & 0 & 11 & 5 & 0\end{matrix} ] \qquad ( 1 )$$

Exemplarily, in the embodiments of the present disclosure, the target filter kernel is the heart-shaped filter kernel, and the predetermined filter kernel size is 9×9. Therefore, the first template image acquired by the image processing apparatus is as shown in FIG. 3B. After the first template image is scaled to the size of 9×9 to obtain the second template image, the two-dimensional array corresponding to the second template image is determined as the heart-shaped filter kernel. The specific heart-shaped filter kernel is as shown in formula (2):

$$\frac{1}{5963} [ \begin{matrix}2 & 45 & 68 & 30 & 0 & 30 & 68 & 45 & 2 \\ 66 & 130 & 130 & 129 & 73 & 129 & 130 & 130 & 66 \\ 112 & 130 & 130 & 130 & 130 & 130 & 130 & 130 & 112 \\ 96 & 130 & 130 & 130 & 130 & 130 & 130 & 130 & 96 \\ 31 & 130 & 130 & 130 & 130 & 130 & 130 & 130 & 31 \\ 0 & 50 & 130 & 130 & 130 & 130 & 130 & 50 & 0 \\ 0 & 0 & 50 & 130 & 130 & 130 & 50 & 0 & 0 \\ 0 & 0 & 0 & 48 & 130 & 48 & 0 & 0 & 0 \\ 0 & 0 & 0 & 0 & 16 & 0 & 0 & 0 & 0\end{matrix} ] \qquad ( 2 )$$

It can be understood that, in the embodiments of the present disclosure, the target filter kernel determined by the image processing apparatus may be a circular filter kernel, i.e., a filter kernel having a circular spot effect. Because a circle is of a regular figure, not only the circular filter kernel may be generated through steps S201-S203, but also the mathematical formula about the circular filter kernel in the prior art may be directly invoked. Moreover, for a filter kernel needing to have an irregular-shaped spot effect, such as the pentagonal filter kernel and the heart-shaped filter kernel, may be expressed by mathematical formulas by means of a large number of calculations, but it is complicated. Therefore, corresponding filter kernels may be determined by using a template conversion mode provided in steps S201-S203. The specific mode of determining the target filter kernel is not limited in the embodiments of the present disclosure.

It can be understood that, in the prior art, in the case that a background-blurred image is obtained by using a single-lens reflex camera, a circular spot effect is present on the image generally, so that the display beauty of the image is improved. In the embodiments of the present disclosure, the image processing apparatus may provide not only a circular filter kernel allowing an image to produce a circular spot effect, but also filter kernels in various other shapes, such as a heart-shaped filter kernel, a pentagonal filter kernel, etc., so that the image can produce a heart-shaped spot or a pentagonal spot.

At S102, according to the target filter kernel and depth of field information corresponding to an input image, filtering and distinguishing processing is performed on the input image to obtain a non-background area and a blurred background area of the input image.

In the embodiments of the present disclosure, after determining the target filter kernel, the image processing apparatus may further acquire the depth of field information corresponding to the input image, so as to perform filtering and distinguishing processing on the input image according to the target filter kernel and the depth of field information corresponding to the input image, thereby obtaining the non-background area and the blurred background area of the input image.

It should be noted that, in the embodiments of the present disclosure, the input image is an image displayed on a current preview interface of the image processing apparatus, i.e., an image entering the field of view when the image processing apparatus is photographing. The specific input image is not limited in the embodiments of the present disclosure.

It should be noted that, in the embodiments of the present disclosure, the image processing apparatus may also acquires the depth of field information corresponding to the input image while acquiring the input image. The depth of field information corresponding to the input image may represent the distances of different objects in the input image. The specific depth of field information corresponding to input image is not limited in the embodiments of the present disclosure.

In the embodiments of the present disclosure, the performing filtering and distinguishing processing on the input image according to the target filter kernel and the depth of field information corresponding to the input image to obtain the non-background area and the blurred background area of the input image by the image processing apparatus includes: filtering the input image according to the target filter kernel to obtain the blurred image, distinguishing the background area and the non-background area of the blurred image as well as the background area and the non-background area of the input image according to the depth of field information, and determining the background area of the blurred image as a blurred background area.

It should be noted that, in the embodiments of the present disclosure, the target filter kernel may be a circular filter kernel, a heart-shaped filter kernel, or a pentagonal filter kernel. Therefore, the image processing apparatus performs processing on the input image according to the target filter kernel so that the obtained blurred image has a corresponding spot shape.

Specifically, in the embodiments of the present disclosure, in order to obtain a blurred image having a better spot effect, the filtering the input image according to the target filter kernel to obtain a blurred image by the image processing apparatus includes: performing brightness stretching transformation on the input image according to a predetermined brightness transformation mode to obtain a first image, filtering the first image according to the target filter kernel to obtain a second image, and performing brightness stretching inverse transformation on the second image according to the predetermined brightness transformation mode to obtain the blurred image.

It should be noted that, in the embodiments of the present disclosure, the image processing apparatus stores the predetermined brightness transformation mode for performing brightness stretching transformation on the input image and performing inverse brightness stretching transformation on the second image. The specific predetermined brightness transformation mode is not limited in the embodiments of the present disclosure.

It can be understood that, in the embodiments of the present disclosure, the image processing apparatus first performs brightness stretching transformation on the input image to obtain the first image, so that an area where a spot is added during filtering may be quickly found from the first image. The performing stretching inverse transformation on the second image by the image processing apparatus is actually to restore the brightness of the second image to a normal display range, thereby obtaining a blurred image having brightness within the normal display range.

Exemplarily, in the embodiments of the present disclosure, the predetermined brightness transformation mode is as shown in formula (3):

$$y = \{ \begin{matrix}128 {e}^{\frac{x - 128}{32}} , & x > 128 \\ x , & x \leq 128\end{matrix} \qquad ( 3 )$$

When the image processing apparatus performs brightness stretching transformation on the input image according to formula (1) to obtain the first image, x is the brightness value of each pixel point in the input image, and y is the brightness value of each pixel point in the first image; and when inverse brightness transformation is performed on the second image according to formula (3) to obtain the blurred image, y is the brightness value of each pixel point in the second image, and x is the brightness value of each pixel point in the blurred image.

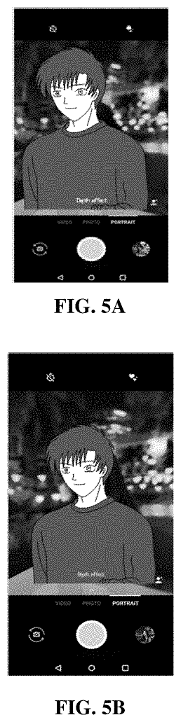

FIG. 4 is a schematic transformation curve of an exemplary predetermined brightness transformation mode provided in the embodiments of the present disclosure. As shown in FIG. 4, for the predetermined brightness transformation mode shown in formula (3), when the image processing apparatus performs brightness stretching transformation on the input image according to the predetermined brightness transformation mode shown in formula (3), pixel points having brightness values less than or equal to 128 in the input image have corresponding brightness values unchanged in the first image, and pixel points having brightness value greater than 128 have corresponding brightness values increased exponentially in the first image, i.e., for the schematic transformation curve, when x is less than or equal to 128, y is small, and when x is greater than 128, y is rapidly increased.

It can be understood that, in the embodiments of the present disclosure, the target filter kernel may have a spot effect, and therefore, after obtaining the first image, the image processing apparatus filters the first image by using the target filter kernel, and the obtained second image has a spot effect, i.e., the second image has a spot shape corresponding to the target filter kernel. Furthermore, the image processing apparatus performs inverse brightness stretching transformation on the second image according to the predetermined brightness transformation mode, and the obtained blurred image also has a spot effect.

Exemplarily, in the embodiments of the present disclosure, the target filter kernel determined by the image processing apparatus is a heart-shaped filter kernel, and the heart-shaped filter kernel has a heart-shaped spot effect. The image processing apparatus performs brightness stretching transformation on the input image according to the brightness transformation mode shown in formula (3) to obtain the first image, then filters the first image by using the heart-shaped filter kernel to obtain the second image, and finally performs inverse brightness stretching transformation on the second image according to the brightness transformation mode shown in formula (3) to obtain the blurred image, Both the second image and the blurred image have the heart-shaped spot effect.

It should be noted that, in the embodiments of the present disclosure, the image processing apparatus may obtain the depth of field information corresponding to the input image, and the image obtained by filtering the input image does not change the depth of field of the image. Therefore, the depth of field information corresponding to the blurred image is actually the same as the depth of field information corresponding to the input image. The image processing apparatus may directly distinguish the background area and the non-background area of the blurred image as well as the background area and the non-background area of the input image according to the depth of field information corresponding to the input image, and at the same time, determine the background area of the blurred image as the blurred background area.

In the embodiments of the present disclosure, the performing filtering and distinguishing processing on the input image according to the target filter kernel and the depth of field information corresponding to the input image to obtain the non-background area and the blurred background area of the input image by the image processing apparatus may further include: distinguishing the background area and the non-background area of the input image according to the depth of field information, and filtering the background area of the input image according to the target filter kernel to obtain the blurred background area.

Specifically, in the embodiments of the present disclosure, the filtering the background area of the input image according to the target filter kernel to obtain a blurred background area by the image processing apparatus includes: performing brightness stretching transformation on the background area of the input image according to the predetermined brightness transformation mode to obtain the first background area, filtering the first background area according to the target filter kernel to obtain the second background area, and performing inverse brightness stretching transformation on the second background area according to the predetermined brightness transformation mode to obtain the blurred background area.

It should be noted that, in the embodiments of the present disclosure, the process of filtering the background area of the input image by the image processing apparatus according to the target filter kernel is exactly the same as the process of directly filtering the input image. The predetermined brightness transformation mode may also be as shown in formula (3), and the only difference is that the processed objects are different. Details are not described here again.

It can be understood that, in the embodiments of the present disclosure, for the filtering and distinguishing processing performed on the input image by the image processing apparatus, distinguishing processing may be performed, and then filtering processing is performed, or filtering processing may be performed first, and then distinguishing processing is performed, i.e., the above-mentioned two filtering processes. However, the image processing apparatus may obtain both the non-background area and the blurred background area, and the specific execution manner is not limited in the embodiments of the present invention.

At S103, the non-background area and the blurred background area are blended to obtain a background-blurred image.

In the embodiments of the present disclosure, after obtaining the non-background area and the blurred background area of the input image, the image processing apparatus may blend the non-background area and the blurred background area to obtain a background-blurred image.

It should be noted that, in the embodiments of the present disclosure, the image processing apparatus may store a predetermined blending mode for blending the non-background area and the background area. The specific predetermined blending mode is not limited in the embodiments of the present disclosure.

It can be understood that, in the embodiments of the present disclosure, the image processing apparatus is actually for blurring the background area of the input image, and the blurred background area after the blurring has the spot effect. For the input image, the background area is not blurred, and the blurred background area has been blurred and has a spot effect. Therefore, the non-background area and the blurred background area are blended according to the predetermined blending mode to obtain the background-blurred image, i.e., the blurring of the background area of the input image is implemented, the foreground still remains the definition of the input image, and the blurred background area has a spot effect.

Exemplarily, in the embodiments of the present disclosure, the predetermined blending mode is Alpha blending. After obtaining the non-background area and the blurred background area of the input image, the image processing apparatus may blend the non-background area and the blurred background area according to the Alpha blending to obtain the background-blurred image.

It should be noted that, in the embodiments of the present disclosure, the Alpha blending is a technology for enabling an object in an image to be transparent, so that the non-background area and the blurred background area may be integrated together. The specific Alpha blending is prior art, and details are not described herein again.

It should be noted that, in the embodiments of the present disclosure, the filter kernel having a spot effect as well as the brightness stretching transformation and inverse brightness stretching transformation are adopted to simulate the spot effect, and an acceleration processing is performed on a terminal, so that the time consumed is reduced. Therefore, after obtaining the background-blurred image, the image processing apparatus may perform real-time preview display of the background-blurred image.

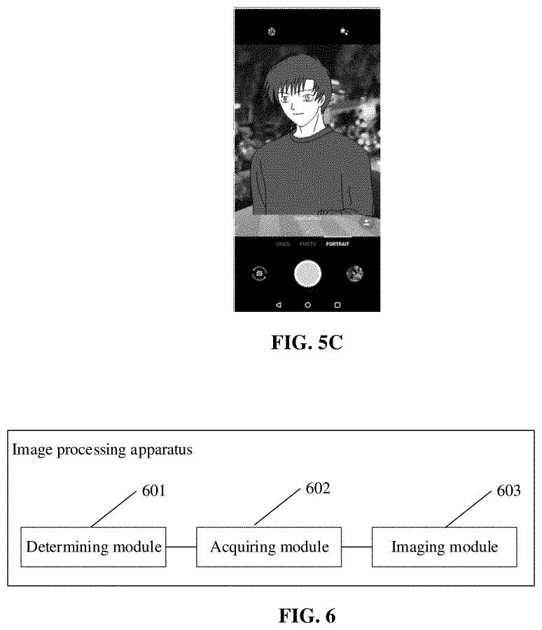

FIG. 5A is a first schematic real-time preview display diagram of an exemplary background-blurred image provided in the embodiments of the present disclosure. As shown in FIG. 5A, the background area of the background-blurred image has been blurred, and has a circular spot, i.e., the target filter kernel is a circular filter kernel.

FIG. 5B is a second schematic real-time preview display diagram of an exemplary background-blurred image provided by the embodiments of the present disclosure. As shown in FIG. 5B, the background area of the background-blurred image has been blurred, and has a heart-shaped spot effect, i.e., the target filter kernel is a heart-shaped filter kernel.

FIG. 5C is a second schematic real-time preview display diagram of an exemplary background-blurred image provided by the embodiments of the present disclosure. As shown in FIG. 5C, the background area of the background-blurred image has been blurred, and has a pentagonal spot effect, i.e., the target filter kernel is a pentagonal filter kernel.

The embodiments of the present disclosure provide an image processing method, where an image processing apparatus determines a target filter kernel, performs, according to the target filter kernel and depth of field information corresponding to an input image, filtering and distinguishing processing on the input image to obtain a non-background area and a blurred background area of the input image, and blends the non-background area and the blurred background area to obtain a background-blurred image. That is to say, in the technical solution of the embodiments of the present disclosure, by performing filtering and distinguishing processing on the input image, and blending the obtained blurred background area and the non-background area, a background-blurred image with a spot effect may be obtained in a short time, thereby supporting the real-time preview display of the background-blurred image, and enabling the effect obtained by photographing to be consistent with the effect seen.

### Embodiment II

Embodiments of the present disclosure provide an image processing apparatus. FIG. 6 is a schematic structural diagram of an image processing apparatus provided by the embodiments of the present disclosure. As shown in FIG. 6, the image processing apparatus includes:

a determining portion 601, configured to determine a target filter kernel;

an acquiring portion 602, configured to perform, according to the target filter kernel and depth of field information corresponding to an input image, filtering and distinguishing processing on the input image to obtain a non-background area and a blurred background area of the input image; and

an imaging portion 603, configured to blend the non-background area and the blurred background area to obtain a background-blurred image. Optimally, the determining portion 601 is specifically configured to acquire a first template image, scale the first template image to a predetermined size of a filter kernel to obtain a second template image, and determine a two-dimensional array corresponding to the second template image as the target filter kernel.

Optimally, the image processing apparatus further includes: a receiving portion 604;

the receiving portion 604 is configured to receive a selection instruction, the selection instruction including a spot type; and

the acquiring the first template image by the determining portion 601 includes: determining the first template image according to the spot type in the selection instruction.

In at least one embodiment of the present disclosure, the acquiring portion 602 is specifically configured to filter the input image according to the target filter kernel to obtain a blurred image, distinguish a background area and a non-background area of the blurred image as well as a background area and a non-background area of the input image according to the depth of field information, and determine the background area of the blurred image as the blurred background area.

In at least one embodiment of the present disclosure, the acquiring portion 602 is specifically configured to perform brightness stretching transformation on the input image according to a predetermined brightness transformation mode to obtain a first image, filter the first image according to the target filter kernel to obtain a second image; and perform inverse brightness stretching transformation on the second image according to the predetermined brightness transformation mode to obtain the blurred image.

In at least one embodiment of the present disclosure, the acquiring portion 602 is specifically configured to distinguish the background area and the non-background area of the input image according to the depth of field information, and filter the background area of the input image according to the target filter kernel to obtain the blurred background area.

In at least one embodiment of the present disclosure, the acquiring portion 602 is specifically configured to perform brightness stretching transformation on the background area of the input image according to the predetermined brightness transformation mode to obtain a first background area, filter the first background area according to the target filter kernel to obtain a second background area, and perform inverse brightness stretching transformation on the second background area according to the predetermined brightness transformation mode to obtain the blurred background area.

The embodiments of the present disclosure provide an image processing apparatus that determines a target filter kernel, performs, according to the target filter kernel and depth of field information corresponding to an input image, filtering and distinguishing processing on the input image to obtain a non-background area and a blurred background area of the input image, and blends the non-background area and the blurred background area to obtain a background-blurred image. That is to say, the image processing apparatus, provided by the embodiments of the present disclosure, performs filtering and distinguishing processing on the input image and blends the obtained blurred background area and the non-background area, so that a background-blurred image with a spot effect can be obtained in a short time, thereby supporting the real-time preview display of the background-blurred image, and enabling the effect obtained by photographing to be consistent with the effect seen.

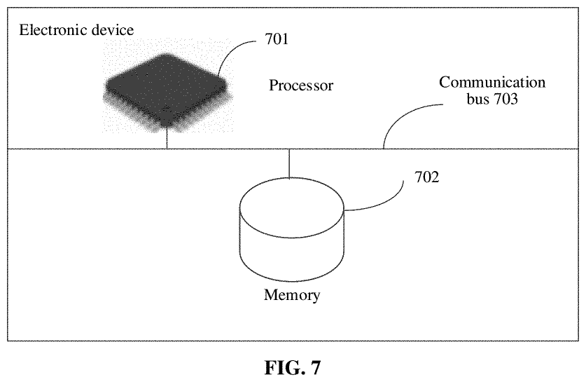

The embodiments of the present disclosure provide an electronic device. FIG. 7 is a schematic structural diagram of an electronic device provided by the embodiments of the present disclosure. As shown in FIG. 7, the electronic device includes: a processor 701, a memory 702, and a communication bus 703, where

the communication bus 703 is configured to implement connection communication between the processor 701 and the memory 702, and

the processor 701 is configured to execute an image processing program stored in the memory 702 to implement the image processing method.

In at least one embodiment of the present disclosure, the electronic device is a mobile phone or a tablet computer.

It is to be noted that, in the embodiments of the present disclosure, the determining portion 601, the acquiring portion 602, the imaging portion 603, and the receiving portion 604 in the image processing apparatus actually correspond to the processor 701 in the electronic device. The steps performed by the determining portion 601, the acquiring portion 602, the imaging portion 603, and the receiving portion 604 in the image processing apparatus are the same as the steps performed by the processor 701 in the electronic device.

The embodiments of the present disclosure further provide a computer-readable storage medium, where the computer-readable storage medium stores one or more programs, and the one or more programs may be executed by one or more processors so as to implement the image processing method. The computer-readable storage medium may be a volatile memory such as a Random-Access Memory (RAM), or a non-volatile memory such as a Read-Only Memory (ROM), a flash memory, a Hard Disk Drive (HDD) or a Solid-State Drive (SSD), and may also be a device including one or any combination of said the above-mentioned memories, such as a mobile phone, a computer, a tablet device, and a personal digital assistant.

A person skilled in the art should know that the embodiments of the present disclosure may be provided as a method, a system, or a computer program product. Therefore, the embodiments of the present disclosure may use a hardware embodiment, a software embodiment, or an embodiment combining software and hardware aspects. Moreover, the present disclosure may use a computer program product that is implemented on one or more computer-usable storage media (including but not limited to a disk memory, an optical memory, etc.) and includes computer usable program codes.

The present disclosure are described with reference to flowcharts and/or block diagrams of the method, apparatus (system), and computer program product according to the embodiments of the present disclosure. It should be understood that each of the processes and/or blocks in the flowcharts and/or block diagrams, and combinations of the flows and/or blocks in the flowcharts and/or block diagrams may be implemented by computer program instructions. These computer program instructions may be provided to a processor of a general purpose computer, a special purpose computer, an embedded processor or other programmable signal processing devices to produce a machine, so that the instructions are executed by the processor of a computer or other programmable signal processing devices to produce a device for implementing functions specified in one or more flows of the flowcharts or in one or more blocks of the block diagrams.

The computer program instructions can also be stored in a computer-readable memory that can direct a computer or other programmable signal processing device to operate in a particular manner, such that the instructions stored in the computer-readable memory produce a product comprising the instruction device. The instruction device implements the functions specified in one or more flows of the flowcharts or in one or more blocks of the block diagrams.

These computer program instructions may also be loaded onto a computer or other programmable signal processing devices such that a series of operational steps are executed on the computer or other programmable devices to produce computer implemented processing, so that instructions executed on a computer or other programmable devices provide steps for implementing the functions specified in one or more flows of the flowcharts or in one or more blocks of the block diagrams.

Those described above are only preferred embodiments of the present disclosure and are not used to limit the scope of protection of the present disclosure.

### INDUSTRIAL APPLICABILITY

In the technical solution of the embodiments of the present disclosure, a target filter kernel is determined, filtering and distinguishing processing is performed, according to the target filter kernel and depth of field information corresponding to an input image, on the input image to obtain a non-background area and a blurred background area of the input image, and the non-background area and the blurred background area are blended to obtain a background-blurred image. That is to say, in the technical solution of the embodiments of the present disclosure, by performing filtering and distinguishing processing on the input image, and blending the obtained blurred background area and the non-background area, a background-blurred image with a spot effect may be obtained in a short time, thereby supporting the real-time preview display of the background-blurred image, and enabling the effect obtained by photographing to be consistent with the effect seen.

1. An image processing method, comprising:
determining, by a terminal device, a target filter kernel;
performing, by the terminal device according to the target filter kernel and depth of field information corresponding to an input image, filtering and distinguishing processing on the input image to obtain a non-background area and a blurred background area of the input image; and
blending, by the terminal device, the non-background area and the blurred background area to obtain a background-blurred image.

2. The image processing method according to claim 1, wherein the determining, by the terminal device, a target filter kernel comprises:
acquiring a first template image, wherein the first template image is an original image corresponding to the target filter kernel;
scaling the first template image to a predetermined size of a filter kernel to obtain a second template image; and
determining a two-dimensional array corresponding to the second template image as the target filter kernel.

3. The image processing method according to claim 2, wherein before determining, by the terminal device, the target filter kernel, the method comprises:
receiving a selection instruction comprising a spot type; and
the acquiring the first template image comprises: determining the first template image according to the spot type in the selection instruction.

4. The image processing method according to claim 1, wherein the performing, by the terminal device according to the target filter kernel and depth of field information corresponding to an input image, filtering and distinguishing processing on the input image to obtain a non-background area and a blurred background area of the input image comprises:
filtering the input image according to the target filter kernel to obtain a blurred image;
distinguishing, according to the depth of field information, a background area and a non-background area of the blurred image as well as a background area and a non-background area of the input image; and
determining the background area of the blurred image as the blurred background area.

5. The image processing method according to claim 4, wherein the filtering the input image according to the target filter kernel to obtain a blurred image comprises:
performing, according to a predetermined brightness transformation mode, brightness stretching transformation on the input image to obtain a first image;
filtering the first image according to the target filter kernel to obtain a second image; and
performing, according to the predetermined brightness transformation mode, inverse brightness stretching transformation on the second image to obtain the blurred image.

6. The image processing method according to claim 1, wherein the performing, by the terminal device according to the target filter kernel and depth of field information corresponding to an input image, filtering and distinguishing processing on the input image to obtain a non-background area and a blurred background area of the input image comprises:
distinguishing a background area and the non-background area of the input image according to the depth of field information; and
filtering, according to the target filter kernel, the background area of the input image to obtain the blurred background area.

7. The image processing method according to claim 6, wherein the filtering, according to the target filter kernel, the background area of the input image to obtain the blurred background area comprises:
performing, according to a predetermined brightness transformation mode, brightness stretching transformation on the background area of the input image to obtain a first background area;
filtering the first background area according to the target filter kernel to obtain a second background area; and
performing, according to the predetermined brightness transformation mode, inverse brightness stretching transformation on the second background area to obtain the blurred background area.

8. The image processing method according to claim 1, wherein after determining, by the terminal device, the target filter kernel, the method further comprises:
acquiring an input image and the depth of field information corresponding to the input image.

9. The image processing method according to claim 1, wherein after obtaining, by the terminal device, the background-blurred image, the method further comprises:
displaying the background-blurred image on a preview interface of the terminal device.

10. An image processing apparatus, comprising: a processor; a memory configured to store an instruction executable by the processor; and a communication bus configured to implement connection communication between the processor and the memory, wherein the processor is configured to:
determine a target filter kernel;
perform, according to the target filter kernel and depth of field information corresponding to an input image, filtering and distinguishing processing on the input image to obtain a non-background area and a blurred background area of the input image; and
blend the non-background area and the blurred background area to obtain a background-blurred image.

11. The image processing apparatus according to claim 10, wherein the processor is configured to:
acquire a first template image, scale the first template image to a predetermined size of a filter kernel to obtain a second template image, wherein the first template image is an original image corresponding to the target filter kernel; and determine a two-dimensional array corresponding to the second template image as the target filter kernel.

12. The image processing apparatus according to claim 11, the processor is further configured to:
receive a selection instruction comprising a spot type; and
the acquiring the first template image comprises: determining the first template image according to the spot type in the selection instruction.

13. The image processing apparatus according to claim 10, wherein the processor is configured to:
filter the input image according to the target filter kernel to obtain a blurred image, distinguish a background area and a non-background area of the blurred image as well as a background area and a non-background area of the input image according to the depth of field information, and determine the background area of the blurred image as the blurred background area.

14. The image processing apparatus according to claim 13, wherein the processor is configured to:
perform, according to a predetermined brightness transformation mode, brightness stretching transformation on the input image to obtain a first image;
filter the first image according to the target filter kernel to obtain a second image; and
perform, according to the predetermined brightness transformation mode, inverse brightness stretching transformation on the second image to obtain the blurred image.

15. The image processing apparatus according to claim 10, wherein the processor is configured to:
distinguish a background area and the non-background area of the input image according to the depth of field information; and
filter, according to the target filter kernel, the background area of the input image to obtain the blurred background area.

16. The image processing apparatus according to claim 15, wherein the processor is configured to:
perform, according to a predetermined brightness transformation mode, brightness stretching transformation on the background area of the input image to obtain a first background area;
filter the first background area according to the target filter kernel to obtain a second background area; and
perform, according to the predetermined brightness transformation mode, inverse brightness stretching transformation on the second background area to obtain the blurred background area.

17. A non-transitory computer-readable storage medium, having stored thereon one or more programs that, when being executable by one or more processors, cause the processor to implement a image processing method, the method comprising:
determining a target filter kernel;
performing, according to the target filter kernel and depth of field information corresponding to an input image, filtering and distinguishing processing on the input image to obtain a non-background area and a blurred background area of the input image; and
blending the non-background area and the blurred background area to obtain a background-blurred image.

18. The non-transitory computer-readable storage medium according to claim 17, wherein the determining a target filter kernel comprises:
acquiring a first template image, wherein the first template image is an original image corresponding to the target filter kernel;
scaling the first template image to a predetermined size of a filter kernel to obtain a second template image; and
determining a two-dimensional array corresponding to the second template image as the target filter kernel.

19. The non-transitory computer-readable storage medium according to claim 17, wherein the performing, according to the target filter kernel and depth of field information corresponding to an input image, filtering and distinguishing processing on the input image to obtain a non-background area and a blurred background area of the input image comprises:
filtering the input image according to the target filter kernel to obtain a blurred image;
distinguishing, according to the depth of field information, a background area and a non-background area of the blurred image as well as a background area and a non-background area of the input image; and
determining the background area of the blurred image as the blurred background area.

20. The non-transitory computer-readable storage medium according to claim 18, wherein the filtering the input image according to the target filter kernel to obtain a blurred image comprises:
performing, according to a predetermined brightness transformation mode, brightness stretching transformation on the input image to obtain a first image;
filtering the first image according to the target filter kernel to obtain a second image; and
performing, according to the predetermined brightness transformation mode, inverse brightness stretching transformation on the second image to obtain the blurred image.
